(19) United States
(12) Patent Application Publication
(10) Pub. No.: US 2026/0093063 A1
(43) Pub. Date: Apr. 2, 2026

(54) RECONFIGURABLE OPTICAL IMAGING SYSTEM WITH A CHANGEABLE REFLECTION FILTER

(71) Applicant: Nanohmics, Inc., Austin, TX (US)

(72) Inventors: Chris W. Mann, Austin, TX (US); Kieran Lerch, Hood River, OR (US); Andrew Foley, Austin, TX (US)

(73) Assignee: Nanohmics, Inc., Austin, TX (US)

(21) Appl. No.: 19/330,954

(22) Filed: Sep. 17, 2025

Related U.S. Application Data
(60) Provisional application No. 63/701,976, filed on Oct. 1, 2024.

(51) Int. Cl. G02B 5/26; G02B 5/04; G02B 7/00

(52) U.S. Cl. CPC G02B 5/26; G02B 5/04; G02B 7/006

(57) ABSTRACT

An optical imaging system includes an object-side lens, a prism, an EMR reflection filter, an image-side lens, and an image sensor. The EMR reflection filter is disposed substantially at a pupil plane of the optical imaging system. The optical imaging system is configured to receive and filter electromagnetic radiation and to reflect the filtered electromagnetic radiation back into the prism, which then passes the filtered electromagnetic radiation to a detector for imaging the filtered radiation. The imaging system is readily reconfigurable by virtue of having a changeable EMR reflection filter.

### STATEMENT OF FEDERALLY SPONSORED RESEARCH

The invention was made, in part, with government support under contract M67854-21-C-6511 awarded by Marine Corps Systems Command and contract FA945322-C-A013 awarded by Air Force Research Laboratory. The government has certain rights in the invention.

### TECHNICAL FIELD

The invention relates to spectral imaging and to a reconfigurable optical imaging system featuring a changeable filter that may be configured for operation in reflection mode and to methods for using the optical imaging system.

### GENERAL DESCRIPTION

Many optical imaging systems, such as for example a camera or other imaging system, employ optical filters to enhance the imaging of, or to selectively image, specific wavelengths of electromagnetic radiation (EMR). Such techniques can allow for the acquisition of useful information about a scene or an object that is being imaged. Useful optical filters for an imaging system may include spectral filters (e.g., bandpass, notch, longpass, and shortpass filters), neutral density filters, and/or polarimetric filters to name a few. In one exemplary use, one or more optical filters may be used to enhance the imaging of or to selectively image selected portions of the electromagnetic spectrum by placing them into an optical imaging system in front of a broadband image sensor.

In many imaging systems, transmissive optical filters have traditionally been used. Transmissive optical filters are often bandpass or bandstop filters that allow for the passage of selected wavelengths or wavelength ranges of EMR (e.g., light) through the filter, while blocking passage through the filter of other wavelengths or wavelength ranges of EMR. Light filtering by a transmissive filter may occur when a portion of an incident light field passes through the filter to an imager, while other portions of the incident light filed are absorbed or reflected by the filter (i.e., unfiltered light enters the filter and selected wavelengths of light (i.e., filtered light) pass through the filter exiting from the other side of the filter). Bandpass filters are preferentially transmissive in a selected spectral region. Transmissive light filters for use in the visible (VIS) region of the electromagnetic spectrum are commercially available for use across a broad range of VIS spectral bandwidths.

Transmissive optical filters for use in the VIS spectral region are often manufactured to have multi-layer coatings that accomplish light filtering. Due to the longer wavelengths of radiation in the infrared (IR) spectral region (i.e., infrared radiation), multi-layer filter coatings necessary for effective IR radiation filtering must be considerably thicker than those that are functional with radiation in the visible (VIS) spectral region (i.e., visible radiation). A common problem with the use of the thicker multi-layered, transmissive filters is that they often exhibit different filtering characteristics for light having different angles of incidence at the filter, thus restricting the imaging system to operation with light having a narrow range of incident angles. A frequently used approach to address this angle of incidence issue is to increase the number of coatings in a multi-layer filter coating, which while being an option for use in the VIS spectral region, faces significant manufacturing problems for use in the IR spectral region. In addition, many traditional optical materials are not effective for filtering light in the IR region, leaving fewer optical coating materials available for use with transmissive IR radiation filtering. Specialized optical coatings have been developed for use in the IR region, but these are often prohibitively expensive to make in amounts needed for IR filter manufacturing, or they require cumulative layers that can be tens to hundreds of microns thick, which can lead to unacceptable layer cracking.

Once fabricated, many multi-layer optical filters designed for use in the IR spectral region cannot be tuned or changed to significantly adjust filtering characteristics and consequently are inadequate for many applications. Other optical systems that employ reflective filters, e.g., dichroic prisms having surfaces that are coated with spectrally selective reflective filters, also suffer from the inability to be tuned or changed to significantly adjust filtering characteristics of the optical system after fabrication due to, for example, geometric and assembly constraints.

The aforementioned challenges are exacerbated in optical imaging systems for use with IR EMR in the thermal radiation region (i.e., thermal imaging cameras or thermal imagers sensitive to approximately 8-12 μm wavelength EMR) and optical filters for use with thermal radiation can be especially challenging to manufacture. Thermal imagers are typically operated with extremely small f-numbers, such as f/2 or faster (f/1 is currently the industry-standard). These low-f-number, fast optics require operation with a wider range of incident angles than is required for the slower optics of imagers designed for use in the VIS spectral region.

Plasmonic light filtering technologies have been developed to address some of the aforementioned problems associated with imaging thermal and IR radiation. For example, plasmonic light filters, having few layers of materials that may address some of the problems associated with multi-layer filters, have been developed for selectively absorbing a single narrow spectral band of a specific polarization state of light over a wide range of incident angles. However, despite this progress, a major problem is that these filters are not transmissive at all, i.e., they absorb and/or reflect 100% of incident light and are thus not useful with traditional imaging systems.

U.S. Pat. No. 11,788,887, which is incorporated by reference herein in its entirety, teaches a tunable plasmonic filter, embodiments, and optical configurations that address many of the shortcomings of conventional transmissive optical filters and of previously described plasmonic light filters. For example, U.S. Pat. No. 11,788,887 teaches operating the plasmonic filter in a reflection mode configuration to overcome the lack of light transmittance that is a characteristic of previously described plasmonic filters and teaches plasmonic light filter configurations that enable light filtering over a wide range of incident angles, making it easier to work with fast optics and more dispersive filters and enabling the manufacture of smaller filters with improved portability.

### SUMMARY

A need exists for improved optical imaging systems that enable improved filtering and effective imaging of EMR particularly within the IR and thermal spectral regions. Embodiments described herein teach an optical imaging system that utilizes reflection mode filtering of EMR and an optical prism to fold the optical path of EMR during passage of the EMR to an image sensor. The system is readily reconfigurable in that the EMR reflection filter is readily changeable to adjust the filtering characteristics of the optical imaging system. The optical imaging system also provides for operation with a wide range of incident angles of incoming EMR, addresses the lack of useful materials for filtering in the IR and thermal spectral regions, enables the use of fast, i.e. low f-number optics, allows for a wide field of view, and has significantly reduced size and weight compared to traditional IR and thermal imagers. In many embodiments, the optical imaging system can be useful for multispectral imaging, and may also be used for polarimetric imaging, spectropolarimetric imaging, and other multimodal imaging methods.

In some embodiments, an optical imaging system comprises an object-side lens, a prism, an EMR reflection filter, an image-side lens, and an image sensor, each disposed in an optical path from an object-side to an image-side of the optical imaging system, wherein the object-side lens is configured to receive EMR and pass the received EMR to the prism at a first prism face, wherein the prism is configured to pass the received EMR through the prism to the EMR reflection filter, wherein the EMR reflection filter is disposed substantially at a pupil plane of the optical imaging system, the pupil plane being positioned in the optical path between the object-side lens and the image-side lens, wherein the EMR reflection filter is configured to filter the EMR and to reflect the filtered EMR back into the prism, the prism being configured to pass the reflected, filtered EMR to the image-side lens, the image-side lens being configured to pass the reflected, filtered EMR to the image sensor, and wherein the EMR reflection filter is configured to be changeable to adjust filtering characteristics of the optical imaging system.

In some embodiments, the optical imaging system further comprises a moveable filter mount, and the EMR reflection filter may be secured by the moveable filter mount. In some aspects, the optical imaging system may comprise a plurality of differently configured EMR reflection filters, each of the plurality of differently configured EMR reflection filters being secured by the moveable filter mount. In some aspects, a movable filter mount may be, for example, a filter wheel or a linearly arranged filter holder that can securely house a plurality of EMR reflection filters. In many aspects, the optical imaging system is readily reconfigurable or changeable by exchanging one EMR reflection filter for another differently configured EMR reflection filter. An exchangeable EMR reflection filter is one exemplary embodiment of an EMR reflection filter that is changeable. In some aspects, the optical imaging system is readily reconfigurable or changeable by having an EMR reflection filter that is tunable, such as by way of example only, an electronically tunable filter. A tunable EMR reflection filter is one exemplary embodiment of a changeable filter. In some embodiments, a tunable EMR reflection filter may be a plasmonic filter, which in some aspects may be electronically tunable. In some embodiments, a plasmonic filter comprises a plasmonic metasurface.

In some embodiments, an EMR reflection filter may be positioned on or integrated with a transmissive support substrate that is substantially transparent to the EMR that is passed to the reflection filter. In some aspects, the transmissive support substrate is positioned between the prism and the EMR reflection filter. In some aspects of the optical imaging system, a prism may also serve as a transmissive support substrate. In many embodiments, the pupil plane of the optical imaging system is located substantially at the interface of the support substrate and the EMR reflection filter. In some embodiments, the optical imaging system may further comprise a lens and/or a baffle disposed between the prism and the EMR reflection filter.

In many embodiments, the optical imaging system can be useful for receiving incident radiation, filtering the radiation, and imaging the filtered radiation. In some aspects, the received, incident radiation may comprise infrared and/or thermal radiation. In some aspects, an EMR reflection filter may be configured to reflect at least some infrared and/or thermal radiation, and as such, filtered radiation may comprise infrared and/or thermal radiation. In some aspects, an EMR reflection filter may be configured to preferentially reflect EMR having a selected polarization state.

In some embodiments, a prism may be configured to fold the optical path of received EMR during the passing of the received EMR to an EMR reflection filter. A prism configured in this manner is configured to effect total internal reflection of the received EMR. Similarly, a prism may be configured to fold the optical path of reflected, filtered EMR by effecting total internal reflection of reflected, filtered EMR.

This Summary introduces concepts described in more detail below in the Detailed Description. Not all embodiments and/or aspects may be described in the Summary.

### BRIEF DESCRIPTION OF THE DRAWINGS

The following drawings form part of the specification and are included to demonstrate certain embodiments described herein. Embodiments may be better understood by reference to one or more of these drawings in combination with the description of the embodiments presented herein. Drawings are not necessarily drawn to scale or intended to be. For purposes of clarity, every component or structure that may be part of an optical imager embodiment may not be depicted in every drawing. The use of a letter following an element number is for descriptive purposes only. For example, 107a and 107b each refer to a prism face 107, but may refer to different prism faces in a figure as an aid in understanding the description of the drawing. In some drawings and views, for purposes of clarity and for understanding embodiments of the invention, the relative sizes of structural elements are not necessarily reflective of actual relative sizes in embodiments of the invention.

FIG. 1 is a schematic, cross-sectional side view of an exemplary embodiment of an optical imaging system.

FIG. 2 is a schematic, cross-sectional side view of an exemplary embodiment of an optical imaging system.

FIG. 3 is a schematic, cross-sectional side view of an exemplary embodiment of an optical imaging system and dimensions of various elements and aspects of the imaging system.

FIG. 4 is a schematic, cross-sectional side view of an exemplary embodiment of an optical imaging system having a lens disposed between a prism and an EMR reflection filter.

FIG. 5 is a schematic, cross-sectional side view of an exemplary embodiment of an optical imaging system having an optical baffle disposed between a prism and an EMR reflection filter.

FIG. 6 is a schematic, cross-sectional side view of an exemplary embodiment of an optical imaging system in which a prism serves as a transmissive support for an EMR reflection filter.

FIG. 7 is a schematic, cross-sectional side view of an exemplary embodiment of an optical imaging system comprising a filter wheel.

FIG. 8 is a perspective view of an exemplary embodiment of an optical imaging system comprising a filter wheel.

FIG. 9 is a schematic, cross-sectional side view of a linearly configured moveable filter mount.

FIG. 10 illustrates a method for an optical imaging system with a changeable reflection filter, according to an embodiment.

FIG. 11 illustrates a method for an optical imaging system with a changeable reflection filter, according to an embodiment.

### DETAILED DESCRIPTION

Reference will now be made in detail to certain exemplary embodiments, some of which are illustrated in the accompanying drawings. Certain terms used in the application are first defined. Additional definitions may be provided throughout the application.

The symbol “˜”, which means “approximately”, and the terms “about” or “approximately” are defined as being close to the referenced value, as would be understood by one of ordinary skill in the art. In an exemplary non-limiting embodiment, the terms may be used to mean within 10%, within 5%, within 1%, or within 0.5% of a stated value. For example, in some aspects, “about 4” or “˜4” may mean from 3.6-4.4 inclusive of the endpoints 3.6 and 4.4, and “about 1 nm” may mean from 0.9 nm to 1.1 nm inclusive of the endpoints 0.9 nm and 1.1 nm. All ranges described herein are inclusive of the lower and upper limit values.

As used herein, the term “equal” and its relationship to the values or parameters that are “substantially equal” would be understood by one of skill in the art. Typically, “substantially equal” can mean that the values or characteristics referred to may not be mathematically equal but would function as described in the specification and/or claims. As used herein, “substantially” is meant to mean “wholly” and/or “largely, but not wholly”. The terms “substantially” and “approximately” may account for industry-accepted tolerance for the corresponding term and/or relativity between items.

As used herein, the terms “optic”, “optical”, and “optical imaging system” refer to optics and relate to optics and/or the science of optics and are not limited to reference to “optical radiation” or applications involving “optical radiation”.

Due to manufacturing techniques and/or tolerances, variations of the element shapes as illustrated in the drawings may occur. Thus, the examples described herein are not limited to the specific shapes illustrated in the drawings, but include changes in shapes that may occur during manufacturing and do not affect the intended operation of the optical imaging system.

The terms first, second, and third and the like in the description and in the claims, are used for distinguishing between similar elements and not necessarily for describing a sequential or chronological order.

As used herein, the phrases “at least one of A or B”, “one or more of A or B”, “at least one of A and B”, and “one or more of A and B” are each meant to include one or more of only A, one or more of only B, or any combination and number of A and B. Any combinations having one or more than one of any of the elements or steps listed are also meant to be included by the use of these phrases. For example, the combinations of 1A and 1B, 2A and 1B, 2B and 1A, and 2A and 2B are included. Similar phrases for longer lists of elements or steps (e.g., “at least one of A, B, or C” and “at least one of A, B, and C”) are also contemplated to indicate one or more than one of any element or step alone or any combination including one or more than one of any of the elements or steps listed. As used herein, “one or more of” means “one or more than one of”.

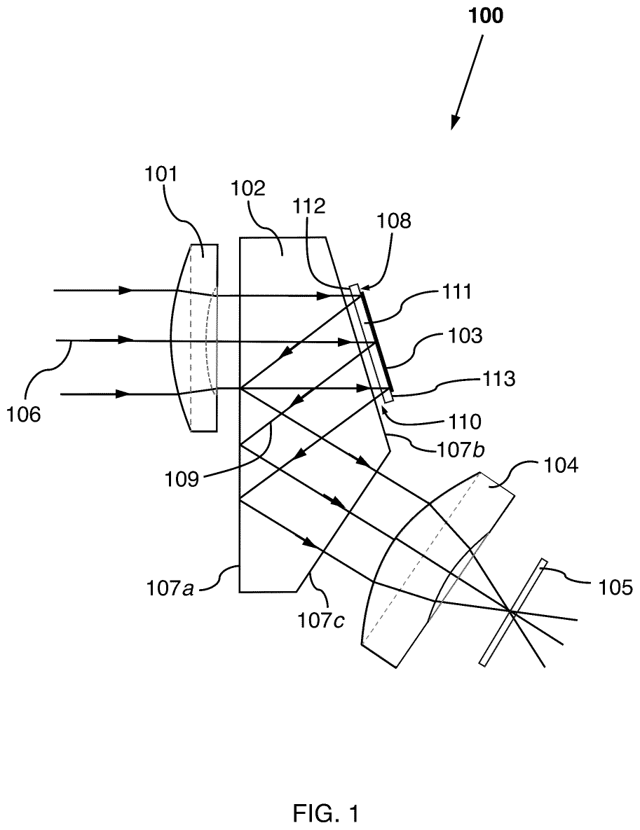

Embodiments described herein include a readily reconfigurable optical imaging system and methods of fabricating embodiments of the reconfigurable optical imaging system. In many embodiments, reconfigurable optical imaging system 100 (FIG. 1) comprises a plurality of optical elements disposed in an optical path from an object-side (also referred to as a scene-side) to an image-side of optical imaging system 100. In some embodiments, the optical elements positioned in an optical path include object-side lens 101, prism 102, EMR reflection filter 103, image-side lens 104, and image sensor 105. In embodiments described herein, optical imaging system 100 is manufactured and assembled to be readily reconfigurable. In many aspects, optical imaging system 100 may be readily reconfigured by changing EMR reflection filter 103, such as by tuning EMR reflection filter 103 or, for example, by exchanging a first EMR reflection filter 103 for a different EMR reflection filter, to adjust the filtering characteristics of optical imaging system 100.

In the exemplary embodiment shown schematically in FIG. 1, object-side lens 101 is disposed and configured to receive EMR 106 and to pass the received EMR 106 to prism 102 at a first prism face 107a, wherein first prism face 107a may not include an EMR reflection filter. Arrowheads present on lines representing EMR 106 and on lines representing reflected, filtered EMR 109 indicate the direction of travel of the respective EMR. In some aspects, prism 102 is configured to pass received EMR 106 through prism 102 to EMR reflection filter 103, without total internal reflection of the EMR within prism 102 during the passage of EMR 106 to EMR reflection filter 103. In some aspects then, prism 102 is not configured to fold the optical path of incident EMR 106 on its passage through prism 102 to EMR reflection filter 103. EMR reflection filter 103 is disposed substantially at a pupil plane 108 of optical imaging system 100, wherein pupil plane 108 is positioned in an optical path between object-side lens 101 and image-side lens 104. Typically, EMR reflection filter 103 is configured to filter incident EMR 106, and subsequently the EMR reflected by EMR reflection filter 103 is filtered EMR 109. In other words, EMR reflection filter 103 generates filtered EMR. Optical imaging system 100 differs from many IR EMR filtering systems that employ filters that operate in transmission mode.

In some embodiments, EMR reflection filter 103 may be integrated with transmissive support substrate 111. In some aspects, such as the exemplary embodiment shown in FIG. 1, the EMR reflection filter 103, which is integrated with the transmissive support substrate 111, may be disposed on or manufactured on a transmissive support substrate 111 that is distinct from the prism 102, and be configured to operate with second prism face 107b. In many aspects, transmissive support substrate 111 may be disposed across a gap 110 from prism 102. In some aspects, transmissive support substrate 111 comprises a first side that faces prism 102, referred to as proximal side 112 of transmissive support substrate 111, and a second side that faces away from prism 102, referred to as distal side 113. In some aspects, EMR reflection filter 103 may be manufactured on or be in contact with distal side 113 of transmissive support substrate 111. In many embodiments, pupil plane 108 is located at the surface of reflection filter 103 where EMR reflection occurs. In this exemplary embodiment, pupil plane 108 is located at the side of EMR reflection filter 103 adjacent to distal side 113 of transmissive support substrate 111. In some aspects, pupil plane 108 is located substantially at the interface of transmissive support substrate 111 and the EMR reflection filter 103. In some embodiments, a transmissive support substrate 111 may be useful for facilitating the fabrication of EMR reflection filter 103, the positioning of EMR reflection filter 103, and/or the changeability of EMR reflection filter 103. In many embodiments, transmissive support substrate 111 may be for example, a wafer, a window, or another appropriate structure that is substantially transparent to incident EMR 106 and that can pass incident EMR 106 to EMR reflection filter 103. In some aspects, transmissive support substrate 111 is an ultra-flat ZnSe substrate. In some embodiments, transmissive support substrate 111 may comprise an antireflective structure, which in some aspects may be a coating on one or more EMR entry surface, such as proximal side 112 and/or distal side 113. Exemplary transmissive support substrates 111 that may be useful in selected embodiments are described in U.S. Pat. No. 11,788,887, which is incorporated by reference herein in its entirety.

In the exemplary embodiment shown in FIG. 1, during operation, EMR 106 is received by object-side lens 101 and passes to prism 102 at a first prism face 107a. EMR 106 passes through prism 102, exiting at a second prism face 107b on the path to EMR reflection filter 103, and without incident EMR 106 rays undergoing total internal reflection. EMR 106 passes through transmissive support substrate 111 to EMR reflection filter 103 and is filtered, and filtered EMR 109 is reflected back through transmissive support substrate 111, across gap 110, and into prism 102 at second prism face 107b. In many embodiments, prism 102 is configured to fold the optical path of reflected, filtered EMR 109 by total internal reflection through prism 102 during passage by prism 102 to image-side lens 104, thereby confining filtered EMR 109 to a relatively small space and enabling manufacture of an optical imaging system 100 having a relatively small size. In this exemplary embodiment, filtered EMR 109 is reflected off first prism face 107a, and exits prism 102 at a third prism face 107c. In embodiments, first prism face 107a may be the same prism face that initially received the EMR 106 from object-side lens 101. Image-side lens 104 is configured to receive and pass filtered EMR 109 to image sensor 105 and to form an image of filtered EMR 109 on image sensor 105. As used herein, unless otherwise noted, prism face 107 refers to an external prism face.

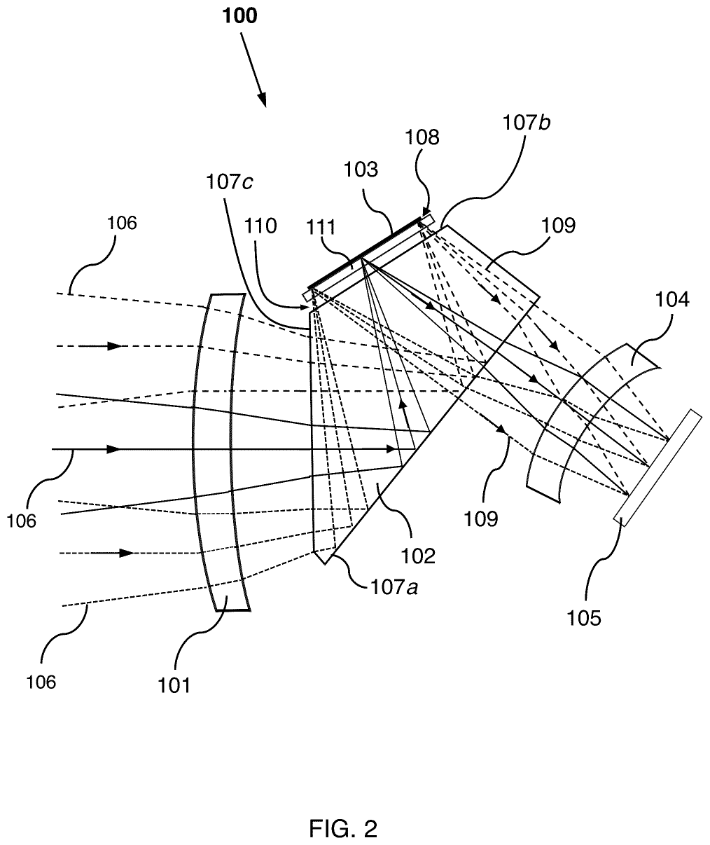

The exemplary embodiment in FIG. 2 is a schematic of a configuration of optical imaging system 100, wherein prism 102 is disposed and configured to receive EMR 106 from object side lens 101 at a first prism face, here 107c, and to pass EMR 106 through prism 102, to EMR reflection filter 103. Here, prism 102 is disposed and configured to fold the optical path of EMR 106 rays by total internal reflection during passage of EMR 106 through prism 102, before the EMR being filtered and reflected by EMR reflection filter 103. EMR 106 may be reflected multiple times internally in prism 102 by the inner faces of prism 102.

In this exemplary embodiment, the shape of prism 102 is similar to that of prism 102 in the embodiment shown in FIG. 1. However, for the embodiment depicted in FIG. 2, prism 102 is disposed in a different orientation with respect to EMR 106 incident on object-side lens 101. Typically, optical imaging system 100 is configured such that EMR 106 passed through prism 102 and interacts only once with EMR reflection filter 103 for filtering and reflection of filtered EMR 109 back into prism 102 thence to image-side lens 104. In this exemplary embodiment, EMR 106 exits prism 102 at second prism face 107b for passage through transmissive support substrate 111 to EMR reflection filter 103. Reflected, filtered EMR 109 passes back through transmissive support substrate 111 across gap 110 to prism 102 and exits prism 102 at a third prism face here 107c for passage to image-side lens 104. In many embodiments, the choice of configuring and positioning prism 102 to fold the optical path of EMR prior to filtering EMR 106 or after filtering EMR 106 will depend on the specific application of optical imaging system 100.

In many embodiments, prism 102 may be a fold prism configured to fold the optical path of EMR 106 and/or reflected, filtered EMR 109, so as to keep EMR 106 and/or reflected, filtered EMR 109 confined to a relatively small space. In addition, folding the beam path (i.e., the optical path) via total internal reflection assists in preventing mechanical interference between object-side 101 and image-side 104 lenses. A fold prism configuration contributes to reducing the overall size of optical imaging system 100 when compared to conventional imaging system configurations that do not create a folded optical path. The fold prism configuration also enables the use of a smaller-sized EMR reflection filter 103, simplifying the filter's manufacture, such as for example photolithographic steps during manufacturing, and contributing to system 100 size reduction. A fold prism configuration of prism 102 also allows for the incorporation of optical imaging system 100 into devices that require a small form factor, such as portable and wearable devices, handheld cameras, and the like.

In many embodiments, optical interfaces in optical imaging system 100 may be configured to have antireflection coatings. Where appropriate, it may be preferred that antireflection coatings be tailored to the angles of incidence of EMR rays. In some aspects, this is most significant at prism 102 and EMR reflection filter 103 optical interfaces, but the choice and configuration of antireflection coatings may also depend on the configuration and application of optical imaging system 100. In many aspects, commercial manufacturers of optical elements can tailor antireflection coatings based on angle of incidence requirements supplied by the optical imaging system user.

In many embodiments, image sensor 105 may be configured for imaging EMR in the IR spectral region. In some aspects, then, image sensor 105 is configured for imaging infrared EMR 109 that has been filtered and reflected by EMR reflection filter 103 and passed through prism 102 and image-side lens 104. In some aspects, image sensor 105 may be configured for imaging thermal radiation. In some embodiments, image sensor 105 may be, for example, a focal plane array (FPA) or other type of IR/thermal EMR detector. One exemplary type of image sensor 105 for imaging filtered EMR 109 in the IR/thermal spectral region is an uncooled detector, such as, for example, an uncooled microbolometer. Other types of image sensors that may be useful with optical imaging system 100 are known to those of skill in the art. In some embodiments, optical imaging system 100 may be disposed in a vacuum-sealed environment, and image sensor 105 may be a cooled detector.

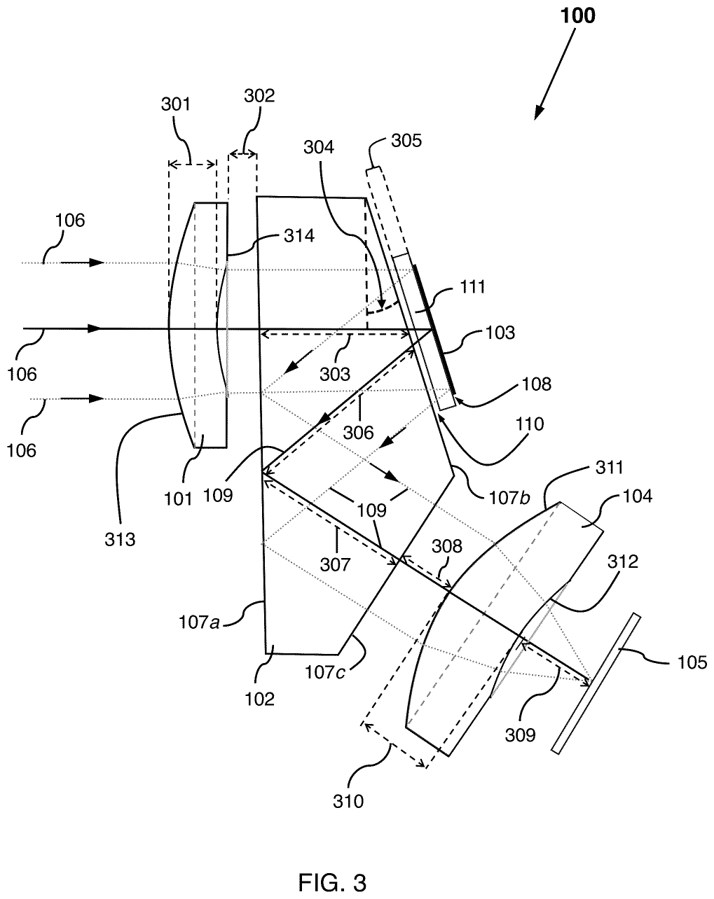

FIG. 3 shows a schematic representation of an exemplary configuration of optical imaging system 100 with element and system parameters. This exemplary configuration is designed for imaging infrared EMR emitted by an object or scene and reflected by EMR reflection filter 103. In particular, the configuration is designed to achieve a 19.2°×15.5° field of view with an image sensor 105 that is a microbolometer detector array operating at f/1.4 and measuring 7.68 mm×6.14 mm and being sensitive to IR EMR having wavelengths in the range of about 8 μm to about 12 μm. In this exemplary configuration, EMR reflection filter 103 is configured as a changeable, plasmonic, metasurface filter configured to reflect EMR in spectral bands having center wavelengths in the range of about 8 μm to about 12 μm. Table 1 illustrates elements, optical prescriptions, and system parameters of the exemplary configuration, as measured by the chief ray. The values are optimized for the specific application described immediately above and can be readily determined with optics simulation software available to those with skill in the art.

TABLE 1

| Element | | | Prescription/ | |
|---|---|---|---|---|
| Number | Element | Composition | Parameter | |
| 101 | Object-Side Lens | Ge | Aspheric | |
| | | | R1 = 28.8 | mm |
| | | | R2 = 27.8 | mm |
| 104 | Image-Side Lens | Ge | Spheric | |
| | | | R1 = 23.2 | |
| | | | R2 = 28.6 | |
| 102 | Prism | ZnSe | Fold prism | |
| 111 | Transmissive Substrate | ZnSe | Polished, Flat | |
| | | plasmonic | reflect EMR from | |
| 103 | EMR Reflection Filter | metasurface | ~8 μm to ~12 μm | |
| 110 | Gap & Gap Distance D_{g} | | 100 | μm |
| 105 | Image Sensor | | Microbolometer Array | |
| 301 | Object-Side Lens | | 4 | mm |
| | Thickness | | | |
| 302 | D₁ | | 5 | mm |
| 303 | Interface Distance D₂ | | 15 | mm |
| 304 | Interface Angle | | 17° | |
| 305 | Support Substrate | | 2 | mm |
| | Thickness | | | |
| 306 | Interface Distance D₃ | | 15.7 | mm |
| 307 | Interface Distance D₄ | | 25 | mm |
| 308 | D₅ | | 5.7 | mm |
| 309 | D₆ | | 10.9 | mm |
| 310 | Image-Side Lens | | 8 | mm |
| | Thickness | | | |

In the exemplary configuration shown in FIG. 3, both object-side lens 101 and image-side lens 104 are positive meniscus lenses. In this exemplary embodiment, object-side surface 313 of object-side lens 101 and object-side surface 311 of image-side lens 104 are both convex. Image-side surface 314 of object-side lens 101 and image-side surface 312 of image-side lens 104 are both concave. As used herein, a statement that a surface of a lens is convex means that at least a region of the surface of the lens is convex, and a statement that a surface of a lens is concave means that at least a region of the surface of the lens is concave.

In some embodiments of optical imaging system 100, at least one of object-side lens 101 or image-side lens 104 may be an aspheric lens. An aspheric lens comprises at least one surface having an aspherical shape. Here, object-side lens 101 is configured as an aspheric lens.

In some embodiments of optical imaging system 100, at least one of object-side lens 101 or image-side lens 104 may be a spheric lens. Here, image-side lens 104 is configured as a spheric lens, and both the object-side surface 311 of image-side lens 104 and the image-side surface 312 of image-side lens 104 have a spherical shape.

For aspheric object-side lens 101, R1 and R2 refer to the radius of a sphere that defines the curvature of the two surfaces of the lens, R1 being associated with the object-side, convex surface 313 and R2 being associated with the concave region of the image-side surface 314. Because both the object-side surface 313 and the image-side surface 314 of object-side lens 101 are aspherical, the radius of curvature defines a base value from which an actual surface departs. The aspherical parameters define that deviation from a sphere precisely according the Equation 1 below. In Equation 1, Z is the departure from the base sphere, c is the curvature of the base sphere, r is the radial distance from the lens vertex, k is the conic constant (which is omitted when 0, as is the case here), and α₁-α₈ are aspherical constants.

$$Z = \frac{{cr}^{2}}{1 + \sqrt{1 - ( 1 + k ) {c}^{2} {r}^{2}}} + {α}_{1} {r}^{2} + {α}_{2} {r}^{4} + {α}_{3} {r}^{6} + {α}_{4} {r}^{8} + {α}_{5} {r}^{10} + {α}_{6} {r}^{12} + {α}_{7} {r}^{14} + {α}_{8} {r}^{16} \qquad ( 1 )$$

The specific aspherical parameters used for object-side lens 101 in this exemplary configuration are unique to a prototype camera and are best determined through numerical optimization for a given application and configuration using an optics simulation and design software suite as discussed further herein below. For this configuration the first four orders are shown in Table 2.

TABLE 2

| Radius | α₁ | α₂ | α₃ | α₄ |
|---|---|---|---|---|
| R1 | 0.0000E+00 | 5.7030E−05 | −2.7030E−06 | 6.9075E−08 |
| R2 | 0.0000E+00 | 9.3255E−05 | −5.5098E−06 | 1.7685E−07 |

In some embodiments, a lens that is part of optical imaging system 100 may be a simple lens comprising a single optical element or a compound lens having a plurality of optical elements that have the combined effect of functioning as a lens. However, in some aspects, it may be desirable to minimize the number of optical interfaces (e.g., by minimizing the number of optical elements of a lens) so as to suppress losses and stray light from interface reflections. In some embodiments, an aspheric lens that is part of optical imaging system 100 may be useful for improving image quality by reducing the effects of or by correcting spherical aberration that can cause image blur. An aspheric lens can be designed to minimize aberration by adjusting the conic constant and aspheric coefficients of the curved surface of the lens. In some embodiments, a freeform lens may be a part of optical imaging system 100 and may be useful for compensating for off-axis aberrations. Freeform lenses are conventionally understood as having a non-rotationally symmetric surface, i.e., the lens lacks radial symmetry. In some aspects a freeform lens may be useful for reducing the mass and/or size of optical imaging system 100.

Referring again to FIG. 3, EMR 106 enters prism 102 at prism face 107a and at normal incidence and exits prism 102 at prism face 107b, where prism face 107b is designed with an interface angle 304 of 17° from normal. EMR 106 is passed through transmissive support substrate 111 and interacts with EMR reflection filter 103, and reflected, filtered EMR 109 re-enters prism 102 at prism face 107b. In this exemplary embodiment, prism 102 is configured to fold the optical path, and filtered EMR 109 undergoes total internal reflection (TIR) within prism 102, reflecting from the original entry prism face 107a with a TIR angle of about 25° and exits prism 102 at normal incidence through prism face 107c. Filtered EMR 109 passes to image-side lens 104, thence to microbolometer, image sensor 105 for imaging. As illustrated in Table 1 for this exemplary configuration, object-side lens 101 has a thickness 301, transmissive support substrate 111 has a thickness 305, and image side lens 104 has a thickness 310. Gap 110 extends from prism face 107b to proximal side 112 (not labeled here for ease of viewing) of transmissive support substrate 111 and has a gap distance D_{g}. D₁ 302 is the distance from the indicated location at the back side (image-side surface 314) of object-side lens 101 to the adjacent face 107a of prism 102; D₂ 303 is the distance from prism face 107a to prism face 107b; D₃ 306 is the distance indicated in FIG. 3 through prism 102 from prism face 107b to prism face 107a along a reflected EMR 109 ray; D₄ 307 is the distance indicated in FIG. 3 from prism face 107a to prism face 107c upon total internal reflection of EMR 109 ray; D₅ 308 is the distance from prism face 107c to the center of convex face (object-side surface 311) of image-side lens 104; and D₆ 309 is the distance from the indicated location at the back side (image-side surface 312) of image-side lens 104 to image sensor 105.

In many embodiments, optical imaging system 100 is designed and configured such that pupil plane 108 is in an optical path of optical imaging system 100 between object-side lens 101 and image-side lens 104 and is positioned substantially at the reflecting surface of EMR reflection filter 103. Object-side lens 101, prism 102, and EMR reflection filter 103 may be disposed and configured such that pupil plane 108 and EMR reflection filter 103 are substantially co-located and are in an optical path and in accord with the specific application of optical imaging system 100 and the needs of a user. Configuring optical imaging system 100 to comprise EMR reflection filter 103 positioned substantially at pupil plane 108 and positioned on transmissive support substrate 111 may contribute to reducing the effects of aberrations and relaxing manufacturing tolerances.

In some aspects, the path length of EMR in imaging system 100 and the composition, refractive index, prescription, shape, surface configuration, type, and/or positioning of optical elements, including their positioning relative to one another, are some parameters that may be adjusted to optimize the location of pupil plane 108 for a given EMR filtering/imaging application. In addition, one or more of these parameters, among others, may also be adjusted to address, for example, manufacturing and size requirements for optical imaging system 100, while maintaining functionality of system 100 in one or more selected spectral regions and for a given application. In many aspects, commercially available optics simulation and design software packages may be useful for simulating and optimizing system configuration and one or more of the aforementioned parameters. Exemplary commercially available design and modeling software packages that may be useful in some embodiments include Zemax OpticStudio (ANSYS® Inc., Canonsburg, Penn., USA), and CODE V® Optical Design Software (Synopsys®, Inc., Sunnyvale, Calif., USA).

In many aspects, EMR reflection filter 103 and other optical elements of optical imaging system 100 may be positioned, secured by (i.e., held securely in place), and/or adjusted by the use of standard optomechanical structures and procedures known to a person having ordinary skill in the art. Some exemplary optomechanical structures include, but are not limited to, optical mounts, optical filter mounts (e.g., filter wheels), stages, plates, and nano- and micro-positioning systems. In some aspects, optomechanical structures may be useful for adjusting one or more gap distances between elements, e.g. gap distance 110, distance 302 between object-side lens 101 and prism 102, distance 308 between prism 102 and image-side lens 104, and distance 309 between image-side lens 104 and image sensor 105, to name a few examples. In some aspects, EMR reflection filter 103 may be disposed on, manufactured on, or otherwise integrated with transmissive support substrate 111, and the integrated transmissive support substrate 111/filter 103 combination may be disposed in and/or secured by a holder, adjusted, and moved into registration with other elements of optical imaging system 100 and into an optical path using a nano- and/or micro-positioning system. This arrangement may allow for the facile exchange of a first EMR reflection filter 103 having a selected first set of filtering characteristics with a second EMR reflection filter 103 having a selected second set of filtering characteristics different from those of the first EMR reflection filter 103. Therefore, this arrangement represents one exemplary manner, i.e., a changeable EMR reflection filter 103, in which optical imaging system 100 may be readily reconfigured to adjust filtering characteristics of optical imaging system 100.

In some embodiments, selected elements of optical imaging system 100 may be disposed in and/or secured by machined structures that facilitate assembly and disassembly of optical imaging system 100 and enable facile exchange and/or rearrangement of system 100 components. By way of example only, in some aspects, a monolithic optomechanical structure may be fabricated to have mounting and registration features and capabilities for each of object-side lens 101 and prism 102. In a similar example, a separate optomechanical structure may be fabricated to have mounting and registration features and capabilities for each of image-side lens 104 and image sensor 105.

In many embodiments, EMR reflection filter 103 disposed on transmissive support substrate 111 may be a tunable reflection filter. This configuration may allow for the facile tuning of EMR reflection filter 103 from a first configuration having a selected first set of filtering characteristics to a second configuration having a selected second set of filtering characteristics different from those of the first EMR reflection filter 103. As such, in these embodiments, EMR reflection filter 103 is changeable by virtue of its tunability. Therefore, this arrangement represents an additional exemplary manner, i.e., tuning a tunable EMR reflection filter 103, in which optical imaging system 100 may be readily reconfigured to adjust filtering characteristics of optical imaging system 100.

In some aspects, a tunable EMR reflection filter 103 may be electronically tunable. In some aspects, a tunable EMR reflection filter 103 may be or may comprise a plasmonic filter. A plasmonic filter may comprise a plasmonic metasurface. In some embodiments, tunable EMR reflection filter 103 may comprise a plasmonic filter that is electronically tunable. In some aspects, a plasmonic, tunable EMR reflection filter 103 may be a notch filter that utilizes impedance matching to effect absorption of EMR. Plasmonic filters and electronically tunable plasmonic filters that may be useful as EMR reflection filter 103 are known in the art. In particular, a plasmonic metamaterial filter, useful embodiments and configurations, and methods for making and using the plasmonic filter can be found in U.S. Pat. No. 11,788,887, which is incorporated by reference herein in its entirety.

In some embodiments, in addition to prism 102, and image-side lens 104, optical imaging system 100 may comprise one or more other optical elements in an optical path between object-side lens 101 and image sensor 105. The one or more additional optical elements may be positioned and configured according to the requirements for a given embodiment of optical imaging system 100 and the needs of the user.

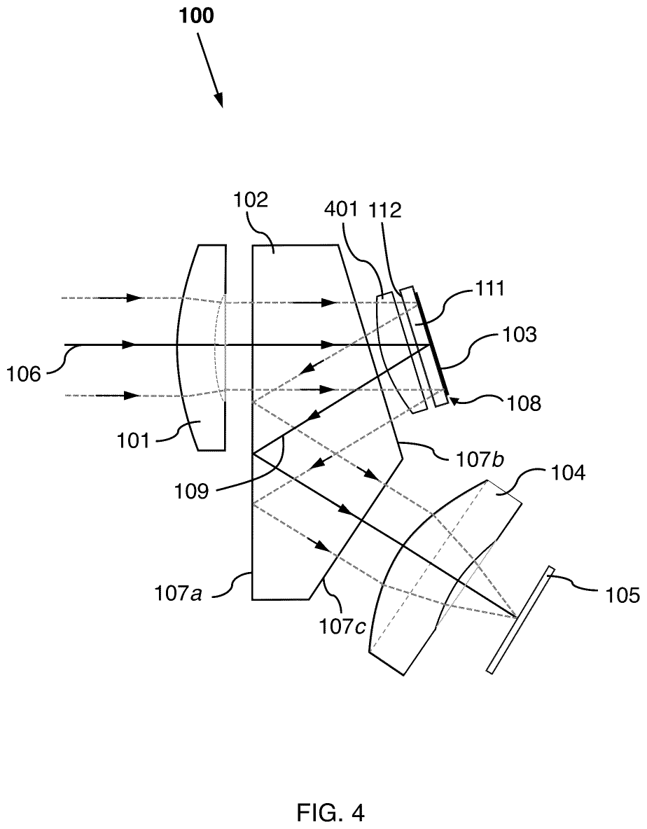

FIG. 4 shows a schematic, cross-sectional side-view of an embodiment of optical imaging system 100 comprising a lens 401 disposed between prism 102 and EMR reflection filter 103, and adjacent to proximal side 112 of transmissive support substrate 111. Lens 401 may be referred to herein as double-pass lens 401, because EMR passes through double-pass lens 401 on passage from prism 102 to reflection filter 103 and on passage from EMR reflection filter 103 back into prism 102.

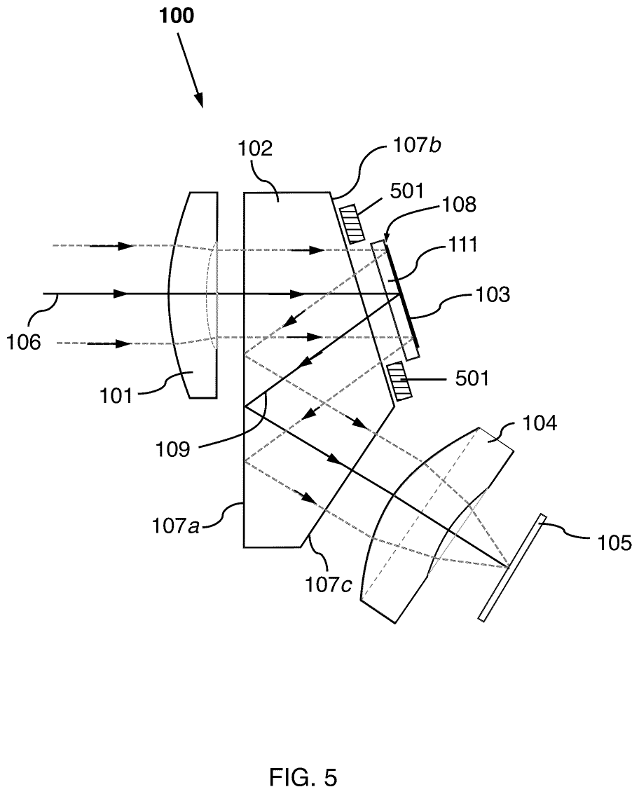

FIG. 5 shows a schematic, cross-sectional side-view of an embodiment of optical imaging system 100 comprising an opto-mechanical element, such as an optical baffle 501, disposed in an optical path of imaging system 100, between prism 102 and EMR reflection filter 103. In some aspects, one or more optical baffle 501 may be useful for suppressing stray or unwanted light and/or reducing internal reflection. Here, EMR 106 that passes through baffle 501 to EMR reflection filter 103 may be filtered and reflected back as filtered light 109, through baffle 501 to prism 102. In some aspects, transmissive substrate 111 may be coated with an EMR absorbing material for suppression of stray or unwanted light while still allowing for the passage of EMR 106 to EMR reflection filter 103 and the passage of filtered EMR 109 from reflection filter 103.

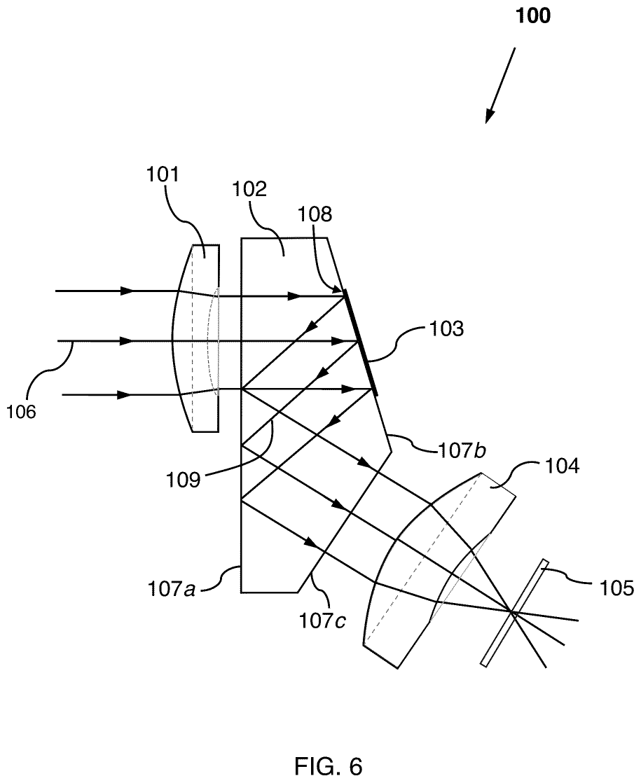

FIG. 6 is a schematic, cross-sectional side-view of an embodiment of optical imaging system 100, wherein prism 102 is a transmissive substrate 111 for EMR reflection filter 103. In some embodiments, such as by way of example only the embodiment shown in FIG. 6, EMR reflection filter 103 may be disposed on prism 102, so as to be in contact with prism 102 at a second prism face, here prism face 107b. In some embodiments, EMR reflection filter 103 may be integrated with prism 102. In some aspects, one or more elements or parts of EMR reflection filter 103 may be manufactured as part of prism 102, such for example only by manufacturing part of EMR reflection filter 103 onto prism 102 at a prism face 107, e.g. prism face 107b in this example. In this exemplary embodiment, EMR 106 is received by object-side lens 101 and passes to prism 102 at a first prism face 107a, thence to a second prism face 107b, and thence to EMR reflection filter 103 for filtering and reflection of filtered EMR 109 back into prism 102 and on to image side lens 104. For embodiments in which prism 102 serves a transmissive substrate for EMR reflection filter 103, pupil plane 108 is positioned at the interface of a prism face 107 (here, prism face 107b) and EMR reflection filter 103. In some embodiments in which EMR reflection filter 103 is integrated with or otherwise fixedly attached to prism 102 without an intervening transmissive support substrate 111, filter characteristics of optical imaging system 100 may be adjusted by tuning EMR reflection filter 103, such as by way of example only, a tunable EMR reflection filter 103 may be an electronically tunable plasmonic filter, such as that previously described elsewhere herein.

In some embodiments, optical imaging system 100 may comprise a moveable filter mount for housing one or more than one EMR reflection filters 103. In some aspects then, optical imaging system 100, may comprise a plurality of EMR reflection filters 103, each filter in the plurality being secured by the moveable filter mount. Some types of moveable filter mounts that may be useful in embodiments of optical imaging system 100 include filter wheel 701 and linearly configured filter holder 901. In some aspects, each of the plurality of EMR reflection filters 103 may be configured differently from one another. In many aspects, a moveable filter mount is configured for securing a plurality of EMR reflection filters 103, so as to make EMR reflection filter 103 readily changeable thereby making optical imaging system 100 readily reconfigurable so as to enable rapid and facile change of filtering characteristics of optical imaging system 100. In some aspects, a moveable filter mount is configured to readily and reversibly position and to hold in place EMR reflection filter 103 substantially at pupil plane 108 in an optical path between object-side lens 101 and image-side lens 104.

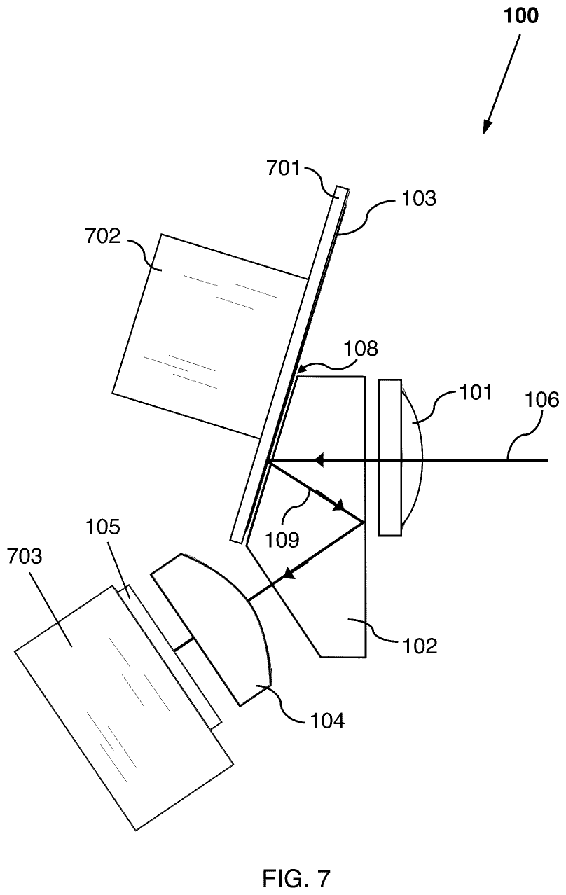

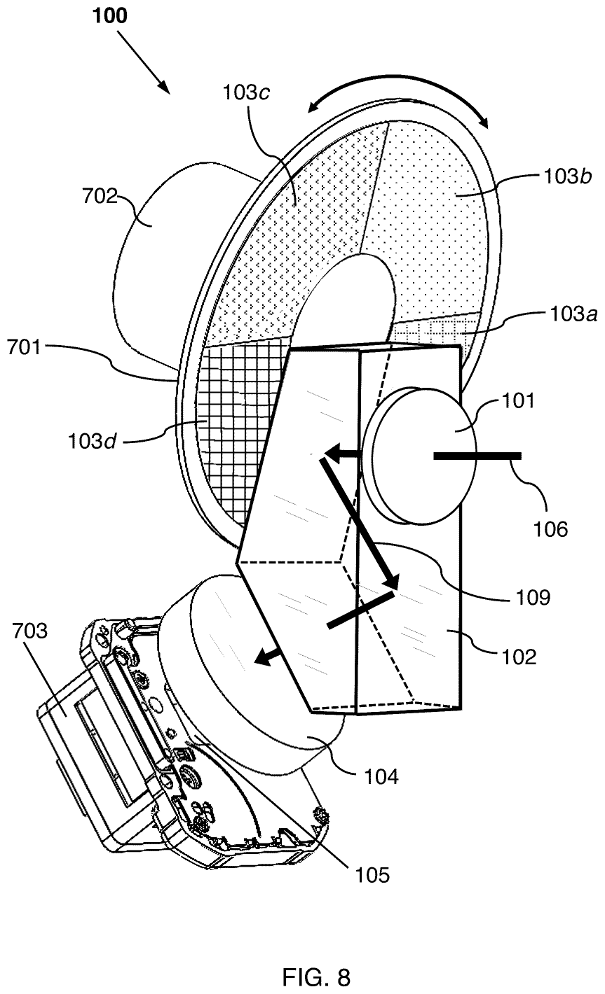

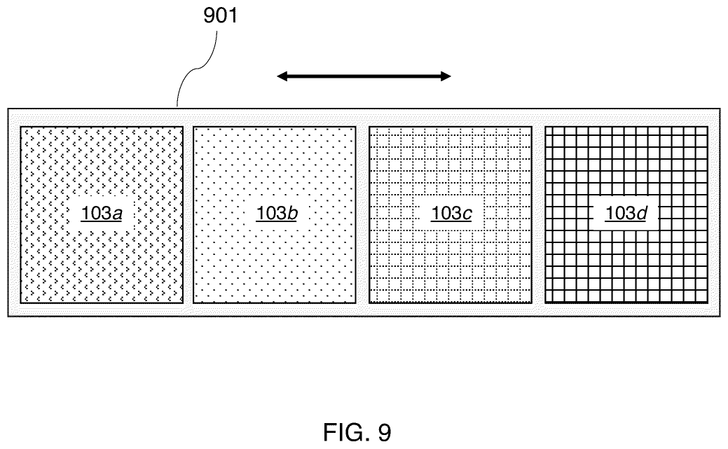

In some embodiments, a moveable filter mount configured for holding one or a plurality of EMR reflection filters 103 may comprise a filter wheel 701 or a linearly configured filter holder 901. In many aspects, a moveable filter mount may be rotated (e.g., a filter wheel 701) or moved horizontally or vertically (e.g., a linearly configured filter holder 901) so as to change the EMR reflection filter 103 that is positioned substantially at pupil plane 108. FIG. 7 and FIG. 8 are schematic illustrations of optical imaging system 100 embodiments comprising a filter wheel 701. As shown in FIG. 7, EMR reflection filter 103 is mounted in filter wheel 701 and is positioned substantially at pupil plane 108. In some aspects, filter wheel 701 includes housing 702, and together wheel 701 and housing 702 may have one or more of a filter holding apparatus, a motor, electrical controls, a shaft, a gear, and/or computer hardware and software for controlling positioning and movement of filter wheel 701. FIGS. 7 and 8 also illustrate image sensor housing 703. FIG. 8 depicts a filter wheel 701 configured for holding plurality of EMR reflection filters 103. Here four EMR reflection filters 103a, 103b, 103c, and 103d are mounted on the wheel, wherein EMR reflection filters 103a, 103b, 103c, and 103d may be positioned directly adjacent to each other. Although filter wheel 701 having four EMR reflection filters 103 is shown in this exemplary embodiment, filter wheel 701 may be configured to securely hold any selected plurality of EMR reflection filters 103, provided that the configuration is compatible with the required dimensions and application of system 100. In many embodiments, filter wheel 701 is rotatable or otherwise adjustable to allow for the rapid, facile exchange of a first EMR reflection filter, e.g. 103a, having a selected first set of filtering characteristics with a second EMR reflection filter, e.g., 103b having a selected second set of filtering characteristics. In many aspects, the selected first set of filtering characteristics is different from the selected second set of filtering characteristics. In many embodiments filter wheel 701 may be configured to hold a plurality of EMR reflection filters 103 and to readily, and reversibly position and secure a selected EMR reflection filter 103 substantially at pupil plane 108 in an optical path between object-side lens 101 and image-side lens 104. This arrangement represents an exemplary embodiment wherein EMR reflection filter 103 is changeable to adjust the filtering characteristics of optical imaging system 100. FIG. 9 illustrates a schematic of an exemplary embodiment of a linear filter holder 901 that is a moveable filter mount configured for securing a plurality of EMR reflection filters 103. It should be noted that in some aspects, it is not a requirement during operation of optical imaging system 100 that an EMR reflection filter 103 be disposed in and/or secured by each filter holder of a moveable filter mount that is configured to hold a plurality of reflection filter 103. A useful filter wheel 701 or linear filter holder 901 may be configured differently than those shown in FIG. 7, FIG. 8, and FIG. 9. By way of example only, useful filter wheels 701 and holders 901 may be sized and/or shaped differently from those shown. Filter wheels 701 and linear filter holders 901 compatible for use with optical imaging system 100 are commercially available, (e.g., from Edmund Optics, Inc., Barrington, NJ, USA and Thorlabs, Inc., Newton, NJ, USA).

In some embodiments, EMR reflection filter 103 mounted in moveable filter mount, such as for example a filter wheel 701 or a linear filter holder 901, may be manufactured on or otherwise be in contact with distal side 113 of transmissive support substrate 111. In some aspects, transmissive support substrate 111 may be positioned between prism 102 and EMR reflection filter 103, and pupil plane 108 is located at the interface of transmissive support substrate 111 and EMR reflection filter 103, adjacent to distal side 113 of transmissive support substrate 111. In some aspects of optical imaging system 100, EMR reflection filter 103 may be positioned immediately adjacent to or in contact with prism 102 without an intervening transmissive support substrate 111.

EMR reflection filter 103 may be any of a variety of filter types, provided that the filter is operable in reflection mode and is compatible with the required dimensions and application of optical imaging system 100. That is, the filter need be capable of receiving EMR 106, filtering the EMR, and reflecting filtered EMR 109 back into prism 102. In many aspects, filtered EMR 109 may be EMR that has been filtered to remove EMR in selected spectral bands, EMR of one or more selected wavelengths, and/or EMR having one or more selected polarization states. In some embodiments, EMR reflection filter 103 may be a dichroic filter that operates in reflection mode or a polarization filter that operates in reflection mode. In some embodiments, EMR reflection filter 103 may be configured to absorb or transmit EMR that is not of interest for imaging with image sensor 105 and to reflect filtered EMR 109 for passage to image sensor 105 for imaging. By way of example, EMR reflection filter 103 may be configured to filter EMR 106 having at least some EMR in the IR and thermal spectral regions and to reflect filtered EMR 109 having wavelengths that are substantially in the IR spectral region (infrared radiation) and/or in the thermal spectral region (thermal radiation), while absorbing or transmitting EMR having wavelengths outside of these regions. Reflected, filtered EMR 109 having wavelengths of EMR to be imaged is passed back into prism 102, thence to image-side lens 104, and on to image sensor 105 for imaging.

In some embodiments, EMR reflection filter 103 may be a notch filter, such as that described in detail in U.S. Pat. No. 11,788,887, and the notch filter may be configured to attenuate the reflection of one or more selected wavelengths or selected polarization states of EMR 106, such that reflected, filtered EMR 109 is lacking EMR having the selected one or more wavelengths or selected one or more polarization states.

In some embodiments, EMR reflection filter 103 may be configured to reflect at least one wavelength of substantially polarized EMR. In these embodiments then, filtered EMR 109 will comprise at least one wavelength of substantially polarized EMR. In some embodiments, EMR reflection filter 103 may be configured to reflect EMR regardless of the polarization state of the at least one wavelength of incident electromagnetic radiation 106. In these embodiments, reflected, filtered EMR 109 may comprise EMR having different polarization states. In some embodiments, EMR reflection filter 103 may be configured to preferentially reflect at least one wavelength of EMR having a selected polarization state.

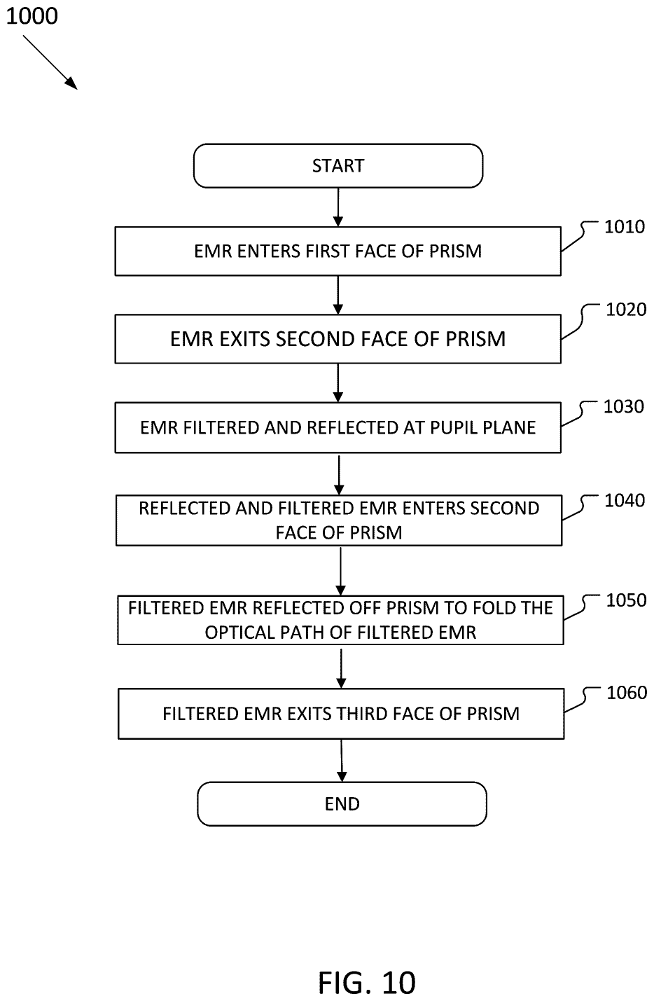

FIG. 10 illustrates a method 1000 for an optical imaging system with a changeable reflection filter, according to an embodiment. The operations of method 1000 presented below are intended to be illustrative. In some embodiments, method 1000 may be accomplished with one or more additional operations not described, and/or without one or more of the operations discussed. Additionally, the order in which the operations of method 400 are illustrated in FIG. 10 and described below is not intended to be limiting.

At operation 1010, EMR may be received by an object-side lens, and pass through a prism at a first face of the prism at a first angle.

At operation 1020, the EMR may exit the prism at a second face of the prism at the first angle, and pass through a transmissive support substrate.

At operation 1030, the EMR may be reflected by a EMR reflection filter at pupil plane.

At operation 1040, The filtered EMR may pass through the transmissive support substrate, and reenter the prism at the second face of the prism at a second angle.

At operation 1050, the filtered EMR may be totally reflected off the first face of the prism to fold the optical path of the filtered EMR.

At operation 1060, the filtered EMR may exit the prism at a third face of the prism, and may be received by an image-side lens.

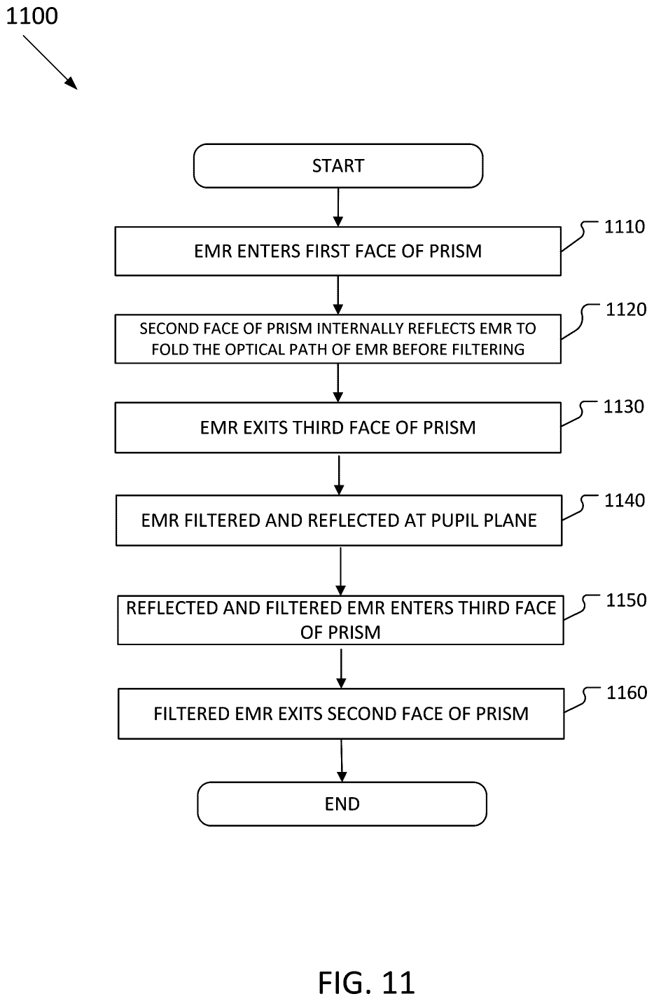

FIG. 11 illustrates a method 1100 for an optical imaging system with a changeable reflection filter, according to an embodiment. The operations of method 1100 presented below are intended to be illustrative. In some embodiments, method 1100 may be accomplished with one or more additional operations not described, and/or without one or more of the operations discussed. Additionally, the order in which the operations of method 1100 are illustrated in FIG. 11 and described below is not intended to be limiting.

At operation 1110, EMR may be received by an object-side lens, and pass through a prism at a first face of the prism at a first angle.

At operation 1120, the EMR may be internally reflected off a second face of the prism to fold the optical path of the EMR before filtering.

At operation 1130, the EMR may exit the prism at a third face of the prism at a second angle, which is different than the first angle, and pass through a transmissive support substrate.

At operation 1140, the EMR may be reflected by a EMR reflection filter at pupil plane.

At operation 1150, the filtered EMR may pass through the transmissive support substrate, and reenter the prism at the third face of the prism at a second angle.

At operation 1160, the filtered EMR may exit the prism at the second face of the prism, and may be received by an image-side lens.

In many embodiments, optical imaging system 100 is useful for spectral imaging, including for multispectral imaging. In many embodiments of spectral imaging, an imaging system gathers EMR from a scene and separates the radiation into individual wavelengths or narrow spectral bands. A detector (i.e., image sensor 105) then detects and measures the spectrally separated radiation and converts the resulting information to electrical signals that represent the spectral composition and intensity of the radiation. In some aspects, electrical signals may be passed to digitizer board which converts the infrared images into digital form and passes the digital image information to processor board. Typically, the spectral imaging information is further computationally processed.

In many embodiments, various elements of optical imaging system 100 may be in communication with a computing device, data processor, or other hardware and software useful for data analysis. Examples of data processors that may be useful in aspects of the invention include but are not limited to one or more of a microprocessor, microcontroller, field-programmable gate array (FPGA), graphics processing unit (GPU), and other processor that can be used for analyzing filtered EMR 109 reflected by EMR reflection filter 103. In some aspects, a data processor may also comprise computer software for calibration and/or for executing algorithms for determination and for analysis of reflected, filtered EMR 109. In some embodiments, machine-executable instructions can be stored on an apparatus in a non-transitory computer-readable medium (e.g., machine-executable instructions, algorithms, software, computer code, computer programs, etc.). When executed by a data processor, instructions may cause the processor to receive data about reflected, filtered EMR 109 and/or about one or more selected configurations of EMR reflection filter 103 and/or may cause the processor to perform analysis of received data and/or to execute a process. In some aspects, the machine-executable instructions can cause the data processor to receive an input of data on reflected, filtered EMR 109, determine information about reflected, filtered EMR 109, store data and information on a memory device that is communicatively coupled to the processor, analyze input data, transfer information about the filtering characteristics of one or more selected configurations of optical imaging system 100 or EMR reflection filter 103, or to perform any combination of these functions.

Computational devices, components, and computer media that may be useful in embodiments described herein include, but are not limited to one or more than one of a computer, storage device, communication interface, a bus, buffer, and data or image processors. In some embodiments, computational devices may be configured to perform calibration of EMR reflection filter 103 and/or of optical imaging system 100 or to receive, store, or process measurements that result from reflection of EMR by EMR reflection filter 103. In some embodiments, calibration, spectral component determination, implementing an algorithm, analysis of spectral and polarization components of incident EMR 106 and/or reflected, filtered EMR 109, and any compatible process related to operation of optical imaging system 100 may be implemented on a tangible computer-readable medium comprising computer-readable code that, when executed by a computer, causes the computer to perform one or more than one operations useful in embodiments described herein. A processor or processors can be used in performance of the operations driven by the tangible, computer-readable media. In some embodiments, tangible computer-readable media may be, for example, a CD-ROM, a DVD-ROM, a flash drive, a hard drive, system memory, a non-volatile memory device, or any other physical storage device. Alternatively, the processor or processors can perform those operations under hardware control, or under a combination of hardware and software control. In some embodiments of the invention, data resulting from measurements of response of an instrument, such as sensor response data from image sensor 105 in response to reflected, filtered EMR 109 may be transferred to a storage device for processing at a later time or transferred to another computer system on demand via a communication interface.

In some embodiments, a monitor may be communicatively coupled to the processor and memory device to display input information, e.g., information about incident EMR 106 or other information relevant to operation of EMR reflection filter 103. In some embodiments, instructions stored on the non-transitory machine-readable medium further encode a user interface that provides a graphical display on a monitor. The interface can allow a user to enter parameter information regarding the filtering characteristics of a selected configuration of EMR reflection filter 103, such as for example only, the filtering characteristics of a tunable EMR reflection filter 103 when tuned to one or more than one selected state and/or the filtering characteristics of one or more than one changeable EMR reflection filters 103. In some aspects, additional parameter information, by way of further example, may include one or more than one of image sensor 105 response to reflected, filtered EMR 109. In some embodiments, a user interface may provide a user with options for analyzing the parameter information, such as various methods for displaying and/or saving the input data and/or image sensor 105 response data (e.g., by displaying the data on the user's monitor, sending the data to a specified electronic device or electronic address, printing, and/or saving the data to a particular location). In various embodiments, data regarding spectral imager 100 operation and other instrument operation may be stored as data in a non-transitory storage medium physically connected to EMR reflection filter 103 or to spectral imager 100 (e.g., on an internal memory device such as a hard drive on a computer) and/or stored on a remote storage device that is communicatively connected to EMR reflection filter 103 or to spectral imager 100 (e.g., by a wired or wireless intranet or internet connection and the like). In some embodiments, a user interface may provide the user with options for automatically storing data in a particular location, printing the data, or sending the data to a specified electronic device or electronic address, or any combination of these.

It should be understood that the detailed description and the specific examples, while indicating specific embodiments of the invention, are given by way of illustration only, since various changes, alternatives, variations, and modifications within the spirit and scope of the invention are possible and may be apparent to others based on this detailed description. Embodiments described above illustrate but are not meant to limit the invention. Other objects, features and advantages of the present invention will be apparent from the detailed description.

What is claimed is:

1. An optical imaging system comprising:
disposed in an optical path from an object-side to an image-side of the optical imaging system, an object-side lens, a prism, an electromagnetic radiation (EMR) reflection filter, an image-side lens, and an image sensor,
wherein the object-side lens is configured to receive EMR and pass the received EMR to a first prism face of the prism,
wherein the prism is configured to pass the received EMR through the prism to the EMR reflection filter,
wherein the EMR reflection filter is disposed substantially at a pupil plane of the optical imaging system, the pupil plane being positioned in the optical path between the object-side lens and the image-side lens, without
wherein the EMR reflection filter is configured to filter the EMR and to reflect the filtered EMR back into the prism, the prism being configured to pass the reflected, filtered EMR to the image-side lens, the image-side lens being configured to pass the reflected, filtered EMR to the image sensor,
and wherein the EMR reflection filter is configured to be a changeable filter.

2. The optical imaging system of claim 1, further comprising:
a moveable filter mount, wherein the EMR reflection filter is coupled to the moveable filter mount, wherein the EMR reflection filter is configured to be changeable to adjust filtering characteristics of the optical imaging system.

3. The optical imaging system of claim 2, comprising:
a plurality of EMR reflection filters, each of the plurality of EMR reflection filters being different from one another and being coupled to the moveable filter mount.

4. The optical imaging system of claim 1, wherein the EMR reflection filter is tunable.

5. The optical imaging system of claim 4, wherein the EMR reflection filter is electronically tunable.

6. The optical imaging system of claim 4 wherein the tunable EMR reflection filter comprises a plasmonic filter.

7. The optical imaging system of claim 6, wherein the plasmonic filter comprises a plasmonic metasurface.

8. The optical imaging system of claim 1, wherein the EMR reflection filter is disposed on or integrated with a support substrate, the support substrate being substantially transparent to the EMR passed to the reflection filter.

9. The optical imaging system of claim 8, wherein the support substrate is positioned between the prism and the EMR reflection filter.

10. The optical imaging system of claim 8, wherein the prism is the support substrate.

11. The optical imaging system of claim 8, wherein the pupil plane is located substantially at an interface of the support substrate and the EMR reflection filter.

12. The optical imaging system of claim 1, further comprising:
a lens disposed between the prism and the EMR reflection filter.

13. The optical imaging system of claim 1, further comprising:
a baffle disposed between the prism and the EMR reflection filter.

14. The optical imaging system of claim 1, wherein the received EMR comprises infrared radiation.

15. The optical imaging system of claim 1, wherein the received EMR comprises thermal radiation.

16. The optical imaging system of claim 1, wherein the EMR reflection filter is further configured to preferentially reflect at least one wavelength of EMR having a selected polarization state.

17. The optical imaging system of claim 1, wherein the prism is further configured to effect total internal reflection of at least a portion of the received EMR.

18. The optical imaging system of claim 1, wherein the prism is further configured to effect total internal reflection of at least a portion of the filtered EMR.

19. The optical imaging system of claim 14, wherein the EMR reflection filter is further configured to reflect at least some infrared EMR.

20. The optical imaging system of claim 15, wherein the EMR reflection filter is further configured to reflect at least some thermal radiation.
